(19) United States
(12) Patent Application Publication
(10) Pub. No.: US 2007/0298631 A1
(43) Pub. Date: Dec. 27, 2007

(54) Auto Repair Structure for Liquid Crystal Display Device

(75) Inventors: Ping-Chun Li, Hsin-Chu (TW); Yi-Jun Lu, Hsin-Chu (TW); Lu-Kuen Chang, Hsin-Chu (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: AU OPTRONICS CORPORATION, Hsin-Chu (TW)

(21) Appl. No.: 11/566,736

(22) Filed: Dec. 5, 2006

(30) Foreign Application Priority Data
Jun. 26, 2006 (TW) 95123016

(51) Int. Cl. H01R 13/648

(52) U.S. Cl. 439/94

(57) ABSTRACT

An auto repair structure for liquid crystal display device includes a data line and a gate line. A protective film is formed over the data line and the gate line. A conductive layer and a plurality of contact holes are formed on the protective film. If the data line or the gate line has an open circuit defect, the signal passes through the conductive layer, thereby automatically repairing the liquid crystal display device.

### RELATED APPLICATIONS

The present application is based on, and claims priority from, Taiwan Patent Application Serial Number 95123016, filed Jun. 26, 2006, the disclosure of which is incorporated by reference herein in its entirety.

### BACKGROUND

1. Field of Invention

The present invention relates to a liquid crystal display structure. More particularly, the present invention relates to an auto repair liquid crystal display structure.

2. Description of Related Art

The flat panel display technology has undergone rapid development over the past few years. This development has resulted in the development of relevant industries. Compared to the cathode ray tube (CRT) display, the thin film transistor liquid crystal display (TFT-LCD) has a wider application range owing to characteristics such as light weight, a slim profile, and low power consumption. The TFT-LCD has a great number of thin film transistors formed on a glass substrate as an array. Therefore, the layout on the glass substrate is very complex in terms of controlling these thin film transistors and pixel electrodes which connect the thin film transistors. Due to some mistakes and omissions in the array process, the gate lines and the data lines may form an open circuit or other defects. In order to reduce the cost and improve the yield of the process, there are some methods that can be used to repair the open circuit or other defects.

The common method to repair the defect described above is to form a plurality of repair lines around the array structure. FIG. 1 illustrates a conventional LCD repair structure that contains a plurality of repair lines 106. There are a number of transverse gate lines 102 and a number of vertical data lines 104 in the array structure on the glass substrate.

When the data line 104 has an open circuit 108, thin film transistors after the open circuit 108 cannot receive data signals from the data line. Therefore the data line 104 and the repair line 106 are welded at two intersections of the data line 104 and the repair line 106 to form weld points 110. The data signal can avoid the open circuit 108 and be transmitted through the repair line 106. Then the film transistors after the open circuit 108 can receive the data signal and work normally.

Due to some problems of the array process, the data line 104 and the gate line 102 would have a leaking point (not shown) and form a short circuit. On the other hand, the signal of the data line 104 and the gate line 102 interfere with each other. Hence, welding two intersections of the data line 104 and the repair line 106 to form two weld points, and cutting the data line 104 which is near the leaking point. The data signal can avoid the leaking point and transmit through the repair line 106.

However, the RC time delay of the data signal is increased because the data signal has a longer transmission path to the thin film transistors after this type of repair process. Moreover, because the repair process must move a large-area panel, it reduces the production efficiency. Another problem associated with this repair method is the large glass substrate area consumed by the repair line and reduces the usage rate of the glass substrate.

Therefore, it is desirable to improve the repair structure for liquid crystal display device to reduce the RC time delay of the data signal after repair process, and without consuming the glass substrate area to form repair lines.

### SUMMARY

It is therefore an object of the present invention to provide a liquid crystal display device with a repair structure that is capable of auto repair defects caused by open circuits and appropriately repairing defects caused by the short circuit. Moreover, the signal without transmitting by a longer transmission path after the repairing process and without consuming glass substrate area to form repair lines.

In order to achieve these and other objects of the invention, an auto repair liquid crystal display structure according to an aspect of the present invention includes a conductive line, a protective film, a plurality of contact holes, and a conductive layer. The protective film is formed over the conductive line. The contact holes are formed in the protective film and are vertically extended downward to the conductive line. The conductive layer is formed on the protective film and is parallel with the conductive line, wherein the conductive layer is electrically connected to the conductive line via the contact holes. The conductive line is a data line or a gate line.

When the conductive line has a defect caused by the open circuit, the signal can automatically be transmitted by the conductive layer through the contact hole, and returns to the conductive line after passing through the open circuit.

Therefore, the signal is not transmitted via the long transmission path after the conductive line is repaired. Moreover, this structure could auto repair the open circuit of the conductive line and increase the production efficiency, and not move a panel to repair the open circuit, increases the production efficiency. Furthermore, this repair structure does not have a repair line and increases the usage rate of the glass substrate.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a plan view of the conventional liquid crystal display repair structure;

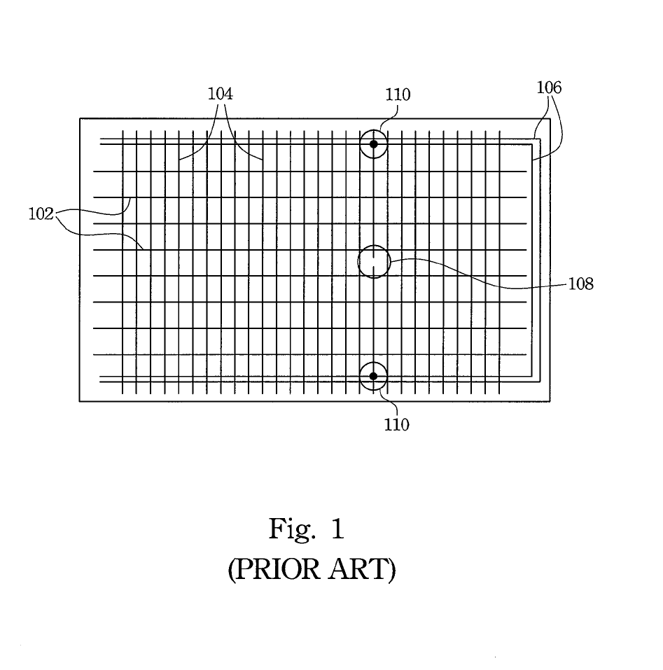

FIG. 2 is a schematic diagram of a plan view of an auto repair liquid crystal display structure of the present invention;

FIG. 3 is a schematic diagram of a cross sectional view of the gate line structure taken along the I-II line in FIG. 2;

FIG. 4 is a schematic diagram of a plan view of the auto repair liquid crystal display structure when the data line and the gate line thereof are shorted;

FIG. 5 is a schematic diagram of a plan view of the second embodiment of an auto repair liquid crystal display structure of the present invention; and

FIG. 6 is a schematic diagram of a plan view of the second embodiment of an auto repair liquid crystal display structure when the data line and the gate line thereof are shorted.

### DESCRIPTION OF THE PREFERRED EMBODIMENTS

Reference is now be made in detail to the present preferred embodiments of the invention, examples of which are illustrated in the accompanying drawings. Wherever possible, the same reference numbers are used in the drawings and the description to refer to the same or like parts.

The following provides a detailed description of embodiments of the invention. The forming process of the data line, gate line, and other structure have been known in the art, the method of the process will not be described in the embodiments, only the usage and the position of the elements is described. Someone skilled in the art could change the structure and materials to satisfy other processes or other design parameters

### First Embodiment

The first embodiment describes an embodiment that uses a complete and continuous conductive layer formed on the protective film above the gate line. The protective layer has a plurality of contact holes extending vertically downward to the gate line. The conductive layer forms a parallel structure with the gate line and connected to the gate line via the contact holes. When the gate line has an open circuit defect, the signal is transmitted through the conductive layer and automatically avoids the open circuit defect. If the gate line and the data line form a leaking point, then the signal is transmitted through the conductive layer and avoids the leaking point by cutting off the both sides of the gate line near the leaking point.

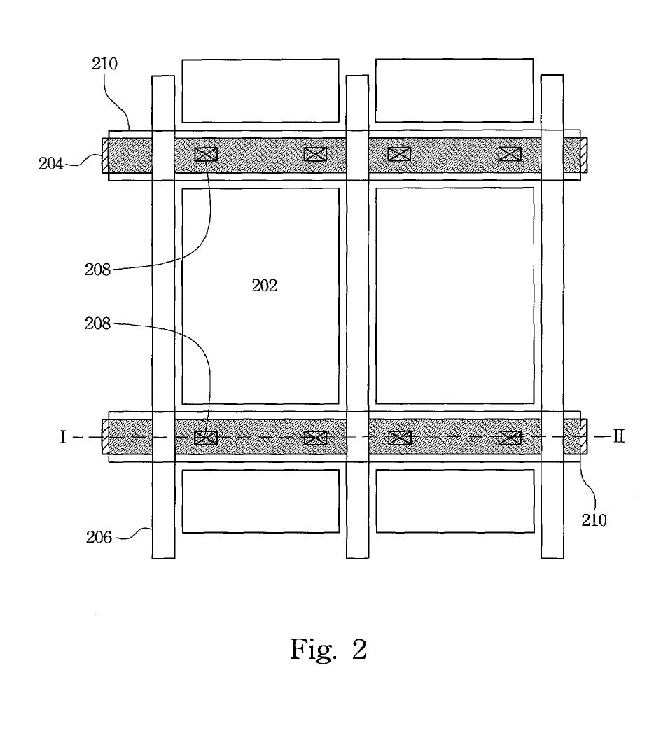

FIG. 2 is a schematic diagram of a plan view of an auto repair liquid crystal display structure of the present invention. The auto repair liquid crystal display structure contains a plurality of pixel electrodes 202, a gate line 204, a data line 206, a plurality of contact holes 208, and a conductive layer 210. The pixel electrodes 202 are made of the ITO (Indium Tin Oxide), IZO (Indium Zinc Oxide), or other similar materials. Every pixel electrode 202 is surrounded by the gate lines 204 and the data lines 206. The data line 206 is formed above the gate lines 204 and crossing the gate lines 204. A protective film (not shown) is formed over the data lines 206 and the gates line 204. In this embodiment, the contact holes 208 are formed in the protective film above the gate line 204 and are vertically extended downward to the gate line 204. The conductive layer 210 is made of the same material of the pixel electrode 202 and is not electrically connected to the pixel electrode 202.

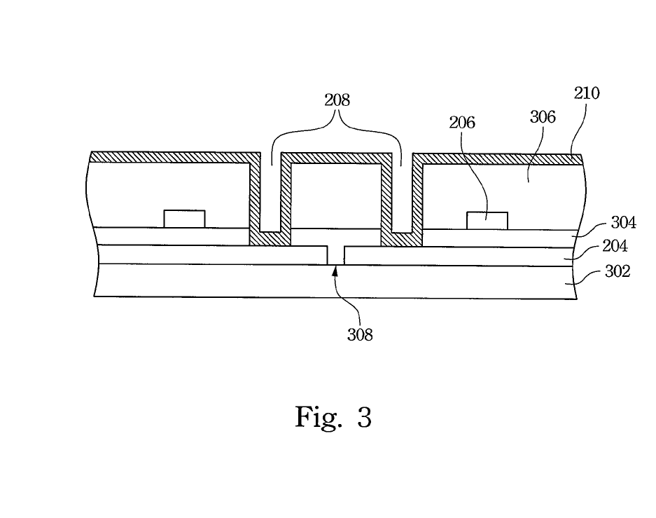

To describe the structure of the invention in detail and the process of the signal transmission, please refer to FIG. 2 and FIG. 3 together. FIG. 3 is a schematic diagram of a cross sectional view of the gate line structure taken along the I-II line in FIG. 2, and presumes that the gate line 204 has an open circuit 308. A gate line 204 is formed on a glass substrate 302 first. Subsequently, a gate insulator 304 is formed over the substrate 302 to cover the gate line 204. The data line 206 is formed on the gate insulator 304 and crossing the gate line 204. On the other hand, the gate line 204 and the data line 206 are formed over the glass substrate 302, and are separated by the gate insulator 304.

The protective film 306 is formed over the data line 206 and the gate line 204. The protective film 306 is an inorganic protective layer, an organic protective layer, or a multilayer structure composed of the inorganic protective layer and the organic protective layer. Next, the contact holes 208 are formed in the protective film 306 above the gate line 204 and are extended vertically downward toward the gate line 204. Moreover, the contact holes 208 are not formed at the intersection of the gate line 204 and the data line 206. Finally, the conductive layer 210 is formed on the protective film 306 above the gate line 204.

If there is an open circuit 308 formed on the gate line 204 caused by some mistake or omission in the array process, then the scanning signal cannot pass through the open circuit 308. However, in this embodiment, the conductive layer 210 is electrically connected to the gate line 204 via the contact holes 208, the scanning signal would automatically transmit through the conductive layer 210. After passing the open circuit 308, the scanning signal also automatically returns to the gate line 204 via another contact hole 208, and avoids the open circuit 308.

In a normal situation, the electrical resistance of the gate line is smaller than the conductive layer, and the scanning signal would not pass through the conductive layer. However, if the gate line has an open circuit, then the electrical resistance of the gate line near the open circuit is infinite. So the scanning signal would automatically transmit through the conductive layer by the contact hole. After passing the open circuit the scanning signal automatically returns to the gate line through the next contact hole.

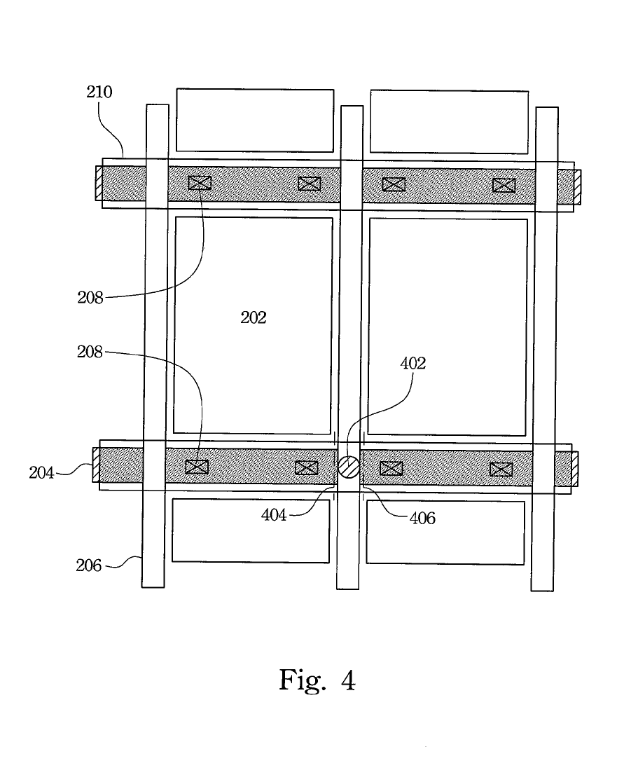

In addition, the repair structure of this invention can also be used to repair a short circuit that is generated between the gate line 204 and the data line 206. FIG. 4 is a schematic diagram of the same area of FIG. 2, and presumes that the area forming a leaking point 402.

Due to some array process or the non-uniform gate insulator problems, the data line 206 and the gate line 204 are electrically connected with each other at the intersection and formed a leaking point 402. Therefore, the scanning signal and the data signal interfere with each other. To solve that situation, the gate line 204 is cut off by a predetermined space from the leaking point 402. For example, cut along a first cutting line 404 and a second cutting line 406 from the bottom side of the glass substrate with a suitable laser. Therefore, the scanning signal is automatically transmitted through the conductive layer 210. Hence, the scanning signal is transmitted by the conductive layer 210 near the leaking point 402, the data signal can transmit through the leaking point 402 with no interference.

This version of the invention can also be applied to auto repair the open circuit of the data line. In this version of the invention, the contact holes are formed on the protective film above the data line and are vertically extended downward to the data line. The conductive layer is disposed on the protective film above the data line and forms a parallel structure with the data line, wherein the conductive layer is electrically connected to the data line via the contact holes. Same as the first embodiment, the data signal could automatically transmit through the conductive layer, after passing the open circuit, the data signal automatically returns to the data line, when the data line has an open circuit. To repair the short circuit that is connected with the gate line and the data line causing a leaking point, the data line is cut off by a predetermined space from the leaking point with a suitable laser. Therefore, the problem of the signal interference can be solved.

### Second Embodiment

The second embodiment describes when the conductive layer is formed on the protective film above the gate line and the data line together. When the gate line or the data line has an open circuit defect, the signal of the data line and the gate line are transmitted through the conductive layer and automatically avoid the open circuit defect. If the gate line and the data line form a leaking point, then the signal is transmitted through the conductive layer and avoids the leaking point by cutting off the both sides of the data line near the leaking point.

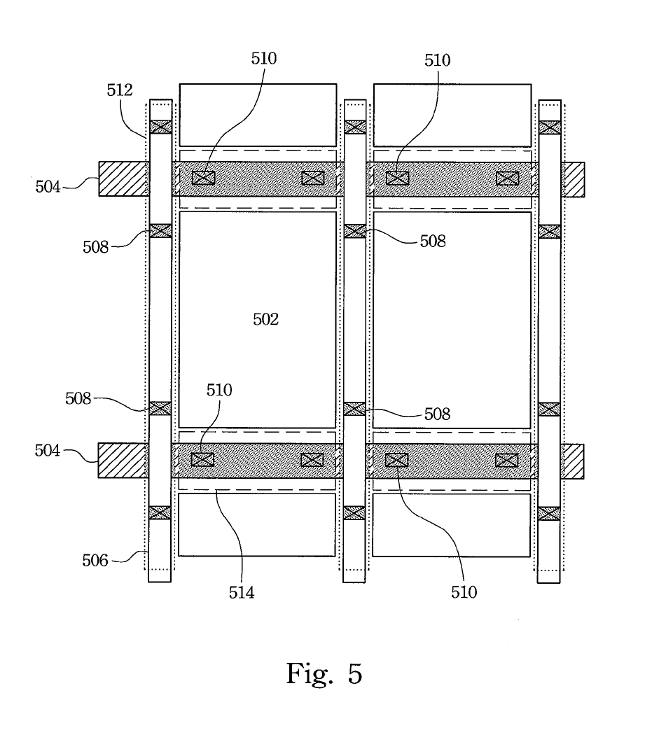

FIG. 5 is a schematic diagram of a plan view of the second embodiment of an auto repair liquid crystal display structure of the present invention. The pixel electrodes 502 are made of the ITO (Indium Tin Oxide), IZO (Indium Zinc Oxide), or other similar materials. Every pixel electrode 502 is surrounded by the gate lines 504 and the data lines 506. The structure of the gate line 504 and the data line 506 are same as the first embodiment, the data line 506 crosses the gate line 504 and does not electrically connect to the gate line 504. A protective film (not shown) is formed over the data line 506 and the gate line 504. The protective film is an inorganic protective layer, an organic protective layer, or a multilayer structure composed of the inorganic protective layer and the organic protective layer.

In this embodiment, a plurality of contact holes 508 and 510 and conductive layers 512 and 514 are formed on the protective film above the gate line 504 and data line 506. The conductive layers 512 and 514 are made of the same material of the pixel electrodes 502 and not electrically connected to the pixel electrode 502.

Moreover, in this embodiment, the conductive layer 512 formed on the protective film above the data line 506 is a complete and continuous structure. The conductive layer 514 formed on the protective film above the gate line 504 is an intermittent structure. The conductive layer 514 formed on the protective film above gate line 504 without electrically connecting to the conductive layer 512 formed on the protective film above the data line. The conductive layer 514 formed on the protective film above gate line 504 only covering above the range of the gate line 504 between two data lines 506. Moreover, the space between these two kinds of conductive layer 512 and 514 is based on the conductive layers 512 and 514 having no electrical connection to each other. The structure of this embodiment is almost the same as the first embodiment. The only change is the arrangement of the conductive layer 514 formed on the protective film above the gate line 506, and the conductive layer 512 formed on the protective film above the data line 504 and the contact holes 508. The difference between second embodiment and first embodiment can be described in FIG. 5, therefore, the cross sectional view of the gate line 504 or the data line 506 structure in this embodiment is not described.

If there is an open circuit formed on the data line caused by some mistake or omission in the array process, then the data signal cannot pass through the open circuit. However, in this embodiment, the conductive layer 512 is electrically connected to the data line 506 via the contact holes 508, the data signal would automatically transmit through the conductive layer 512. After passing the open circuit, the data signal also automatically returns to the data line 506 via another contact hole 508, and avoids the open circuit.

In normal situations, the electrical resistance of the data line 506 is smaller than the conductive layer 512, the data signal would not pass through the conductive layer 512. However, if the data line 506 has an open circuit, then the electrical resistance of the data line 506 near the open circuit is infinite. So the data signal automatically transmits through the conductive layer 512 via the contact holes 508. After passing the open circuit, the data signal automatically returns to the data line 506. If the gate line 504 has an open circuit, the scanning signal also automatically transmits through the conductive layer 514, and auto repair the open circuit of the LCD device.

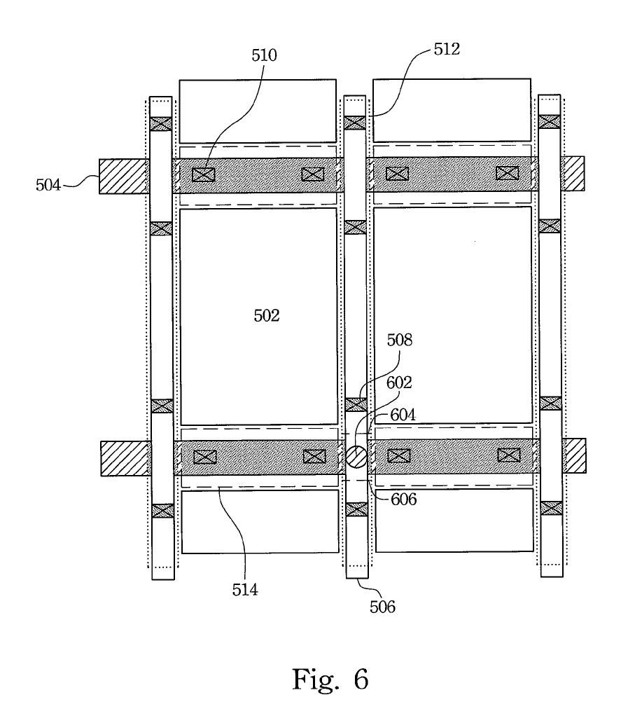

In addition, this repair structure of the invention also can be used to repair a short circuit that is connected with the gate line and the data line causing a leaking point. FIG. 6 is a schematic diagram of the same area of FIG. 5. However, due to the array process or non-uniform gate insulator problems, the data line 506 and the gate line 504 electrically connected with each other at the intersection and formed a leaking point 602. Therefore, the scanning signal and the data signal interfere with each other at the leaking point 602. To solve that situation, the data line 506 is cut of by a predetermined space from the leaking point 602. For example, cut along a first cutting line 604 and a second cutting line 606 from the bottom side of the glass substrate with a suitable laser. The data signal automatically transmits through the conductive layer 512. Therefore, the problem of the signal interference can be solved.

The feature of this embodiment is the conductive layer 512 and 514 are formed on the protective film above the data line 506 and the gate line 504. Either the data line 506 or the gate line 504 has an open circuit, this structure of the embodiment could auto repair the open circuit. Although the conductive layer 514 is not completely and continuously formed above the gate line 504, however, in the array process, the gate line is formed on the glass substrate first. Compared with the data line, the gate line is more thick and wide. Therefore, the probability of forming an open circuit on the gate line is smaller than the data line. This is why in this embodiment the conductive layer is complete and continuous formed on the protective film above the data line, and the structure of the embodiment could efficiently auto repair the open circuit.

As described above, the liquid crystal display device with an auto repair structure according to the present invention has advantages that the signal is not transmitted via the long transmission path after the conductive line is repaired. Moreover, this structure could auto repair the open circuit of the conductive line and increase the production efficiency, and without moving the large-area panel to repair the open circuit, it improves the production efficiency. Furthermore, this repair structure without the repair line and improving the usage rate of the glass substrate.

It will be apparent to those skilled in the art that various modifications and variations can be made to the structure of the present invention without departing from the scope or spirit of the invention. In view of the foregoing, it is intended that the present invention covers modifications and variations thereof provided they fall within the scope of the appended claims.

What is claimed is:

1. An auto repair liquid crystal display structure comprising:
a conductive line;
a protective film formed over the conductive line;
a plurality of contact holes formed in the protective film and vertically extended downwards to the conductive line; and
a conductive layer formed on the protective film and connected to the conductive line via the plurality of contact holes and parallel with the conductive line, wherein the conductive layer is capable of transmitting a signal to avoid an open circuit of the conductive line when the conductive has a open circuit defect.

2. The auto repair liquid crystal display structure of claim 1, wherein the conductive line is a gate line.

3. The auto repair liquid crystal display structure of claim 1, wherein the conductive line is a data line.

4. The auto repair liquid crystal display structure of claim 1, wherein the protective film is an inorganic protective layer, an organic protective layer, or a multilayer structure composed of an inorganic protective layer and an organic protective layer.

5. The auto repair liquid crystal display structure of claim 1, further comprising a plurality of pixel electrodes not electrically connected to the conductive layer.

6. The auto repair liquid crystal display structure of claim 5, wherein the conductive layer and the plurality of pixel electrodes are made of the same material.

7. An auto repair liquid crystal display structure comprising:
a gate line;
a data line formed above the gate line and crossing the gate line;
a protective film formed over the data line and the gate line;
a plurality of contact holes formed in the protective film on the data line and vertically extended downward to the data line; and
a conductive layer formed on the protective film above the data line and connected to the data line via the plurality of contact holes, wherein the conductive layer forms a parallel structure with the data line.

8. The auto repair liquid crystal display structure of claim 7, wherein the protective film is an inorganic protective layer, an organic protective layer, or a multilayer structure composed of an inorganic protective layer and an organic protective layer.

9. The auto repair liquid crystal display structure of claim 7, further comprising a plurality of pixel electrodes surrounded by the gate lines and the data lines and not electrically connected to the conductive layer.

10. The auto repair liquid crystal display structure of claim 9, wherein the conductive layer and the plurality of pixel electrodes are made of the same material.

11. An auto repair liquid crystal display structure comprising:
a gate line;
a data line formed above the gate line and crossing the gate line;
a protective film formed over the data line and the gate line;
a plurality of contact holes formed in the protective film on the gate line and vertically extended downward to the gate line; and
a conductive layer formed on the protective film above the gate line and connected to the gate line via the plurality of contact holes.

12. The auto repair liquid crystal display structure of claim 11, wherein the protective film is an inorganic protective layer, an organic protective layer, or a multilayer structure composed of an inorganic protective layer and an organic protective layer.

13. The auto repair liquid crystal display structure of claim 11, further comprising a plurality of pixel electrodes surrounded by the gate lines and the data lines and not electrically connected to the conductive layer.

14. The auto repair liquid crystal display structure of claim 13, wherein the conductive layer and the plurality of pixel electrodes are made of the same material.

15. An auto repair liquid crystal display structure comprising:
a gate line;
a data line formed above the gate line and crosses the gate line;
a protective film formed over the data line and the gate line;
a plurality of contact holes, formed in the protective film and vertically extended downward to the data line and the gate line; and
a conductive layer formed on the protective film and electrically connected to the gate line and the data line via the plurality of contact holes.

16. The auto repair liquid crystal display structure of claim 15, wherein the protective film is an inorganic protective layer, an organic protective layer, or a multilayer structure composed of an inorganic protective layer and an organic protective layer.

17. The auto repair liquid crystal display structure of claim 15, further comprising a plurality of pixel electrodes surrounded by the gate lines and the data lines and not electrically connected to the conductive layer.

18. The auto repair liquid crystal display structure of claim 17, wherein the conductive layer and the plurality of pixel electrodes are made of a same material.

19. The auto repair liquid crystal display structure of claim 15, wherein the conductive layer is completely and continuously formed on the protective film above the data line, the conductive layer is formed on the protective film above the gate line without covering the intersection of the data line and the gate line, and the conductive layer is formed on the protective film above the data line without electrically connecting to the conductive layer formed on the protective film above the gate line.

20. The auto repair liquid crystal display structure of claim 15, wherein the conductive layer is completely and continuously formed on the protective film above the gate line, the conductive layer is formed on the protective film above the data line without covering the intersection of the data line and the gate line, and the conductive layer is formed on the protective film above the gate line without electrically connecting to the conductive layer formed on the protective film above the data line.
